(19) United States
(12) Patent Application Publication
(10) Pub. No.: US 2014/0281623 A1
(43) Pub. Date: Sep. 18, 2014

(54) WIRELESS DEVICE INCLUDING SYSTEM-ON-A-CHIP HAVING LOW POWER CONSUMPTION

(71) Applicant: QUALCOMM INCORPORATED, San Diego, CA (US)

(72) Inventors: Yu Zhang, San Diego, CA (US); Albert Chee-Ming Cheung, San Diego, CA (US); Chandan K. Agarwalla, San Diego, CA (US); Muralikrishnan Kamalakkannan, Sunnyvale, CA (US)

(73) Assignee: QUALCOMM Incorporated, San Diego, CA (US)

(21) Appl. No.: 13/837,691

(22) Filed: Mar. 15, 2013

(51) Int. Cl. G06F 1/32

(52) U.S. Cl. CPC G06F 1/3234
USPC 713/323

(57) ABSTRACT

A wireless station is disclosed that may quickly enter and/or exit a sleep state and that may reduce power consumption associated with waking up from the sleep state to perform selected low power operations by performing such operations using a set of first instructions stored within an internal memory of the station's processor. If more complex operations such as processing downlink data received from an access point are subsequently desired, then the processor may jump to execution of a set of second instructions stored in an external memory that is coupled to the processor.

### TECHNICAL FIELD

The present embodiments relate generally to wireless devices, and specifically to reducing power consumption in wireless stations.

### BACKGROUND OF RELATED ART

Power consumption is an increasingly important issue for wireless devices (e.g., Wi-Fi enabled devices and Bluetooth-enabled devices). For example, a wireless station (STA) in a wireless local area network (WLAN) may enter a “sleep state” to prolong its battery life. The STA may reduce power consumption in the sleep state by disabling its transceiver(s), placing its processor(s) in a sleep state, and/or by turning off other resources. The STA may periodically wake-up from the sleep state to listen for beacon frames transmitted by an associated access point (AP) of the WLAN. The beacon frames transmitted by the AP may contain a traffic indicator that indicates whether the AP has buffered downlink data for the STA. If the traffic indicator indicates a presence of buffered downlink data, then the STA may remain in the awake state to receive the downlink data. Otherwise, the STA may return to the sleep state.

Because power consumption may be significantly reduced when the STA is in the sleep state, it is desirable to maximize the amount of time that the STA spends in the sleep state. However, the desire to remain in the sleep state may be constrained by the need to periodically receive beacon frames from the AP and/or to perform other tasks. The period of time associated with entering and/or exiting the sleep state may affect how long the STA may remain in the sleep state. In addition, STAs that include a number of components (e.g., a microprocessor, wireless connectivity modules, memory controllers, and other components) integrally formed as a system-on-a-chip (SoC) may take longer to enter and/or exit the sleep state than STAs that include similar components formed as discrete circuits, for example, because of longer timelines and power penalties associated with power management resources of the SoC.

Thus, it is desirable to reduce the time associated with a STA entering and/or exiting the sleep state, and to reduce power consumption associated with waking up from the sleep state to listen for beacon frames.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A wireless device or station (STA) is disclosed that may reduce the time associated with the STA entering and/or exiting the sleep state, and that may reduce power consumption associated with waking up from the sleep state to perform one or more selected low power operations. The low power operations may include, for example, listening for beacon frames to determine whether an associated access point has buffered downlink data for the STA and performing Bluetooth low power page scan (LPPS) operations. In accordance with the present embodiments, the STA includes at least a transceiver, a processor, a system bus, a memory controller, an external memory, and a memory bus. The processor is coupled to the memory controller via the system bus, and the memory controller is coupled to the external memory via the memory bus. The processor also includes an internal (e.g., integrated or on-chip) memory that may store frequently used instructions and data, as described in more detail below.

For some embodiments, the processor may be a wireless connectivity processor that handles wireless communications (e.g., Wi-Fi, Bluetooth, and/or cellular signals). For at least one embodiment, the processor may be a low-power auxiliary processor residing within a mobile service modem or mobile data modem (MSM/MDM) of the STA, and may be configured to complement the operations of a main central processing unit (CPU) provided within the STA. Further, for some embodiments, the processor, the system bus, and the memory controller are formed as integrated components within a system-on-a-chip (SoC), and the transceiver and the external memory are external to the SoC.

The internal memory may store at least a set of first instructions, and the external memory may store at least a set of second instructions. The internal memory and/or external memory may store status and state information reflecting a current operating state of the processor, as well as other information such as system data, application data, data structures, and/or application context data.

The first instructions, which for some embodiments may be a relatively small subset of the second instructions stored in the external memory, are to perform the one or more selected low-power operations for the STA when executed by the processor. The second instructions may include the operating system (OS) for the processor, application software modules, and other programs or software modules for performing functions related to the operation of the STA. The second instructions may also perform one or more of the operations performed by execution of the first instructions stored in the internal memory.

For some embodiments, the processor may execute the first instructions to wake up the processor from a sleep state to receive a beacon frame from an associated access point. The beacon frame may include a delivery traffic indication message (DTIM) bit or a traffic indication map (TIM) bit indicating whether the access point has buffered downlink data for the station. The processor may determine whether the DTIM bit (or TIM bit) is asserted by executing the first instructions residing in the internal memory (e.g., without executing the second instructions residing in the external memory). If the DTIM bit (or TIM bit) is not asserted (e.g., indicating that the access point does not have buffered downlink data for the STA), then the processor may return to the sleep state by executing the first instructions. Conversely, if the DTIM bit (or TIM bit) is asserted (e.g., indicating that the access point has buffered downlink data for the STA), then the processor may process the downlink data received from the access point by executing the second instructions residing in the external memory.

The processor may process the received downlink data by communicating operating state information from the internal memory to the external memory, requesting access to the bus, and then jumping from execution of the first instructions residing in the internal memory to execution of the second instructions residing in the external memory using the operating state information. Thereafter, the processor may determine whether a next interrupt is associated with listening for a subsequent beacon frame by executing the second instructions, and then selectively communicating operating state information from the external memory to the internal memory in response to the next interrupt. More specifically, if the next interrupt is associated with listening for a subsequent beacon frame, then the processor may schedule the next wake up operation to be performed by executing the first instructions residing within the internal memory without executing the second instructions residing in the external memory. Otherwise, the processor may schedule the next wake up operation to be performed by executing the second instructions residing in the external memory.

Performing selected operations by executing the first instructions stored in the internal memory (without accessing the external memory) may provide power savings and increase performance for a variety of reasons. For example, because the internal memory is faster than the external memory, the processor may access data stored in the internal memory much faster than data stored in the external memory. Further, when executing the first instructions stored in the internal memory, the processor may not need to access the external memory, thereby allowing the memory controller and/or system bus to remain in a disabled or a partially disabled state. In addition, by not accessing the external memory, the processor may avoid latencies associated with the external memory and/or may avoid access/contention issues associated with the system bus.

Moreover, the first instructions may include a wake-up routine or boot-up instructions to wake-up the processor and/or to put the processor to sleep without accessing the external memory, thereby increasing the speed with which the STA may enter and exit the sleep state (e.g., as compared to the wake-up and sleep timeline associated with executing corresponding routines stored in the external memory).

### BRIEF DESCRIPTION OF THE DRAWINGS

The present embodiments are illustrated by way of example and are not intended to be limited by the figures of the accompanying drawings, where:

FIG. 1 is a block diagram of a wireless network within which the present embodiments may be implemented;

FIG. 2 is a block diagram of a wireless station (STA) in accordance with some embodiments;

FIG. 3A depicts the internal memory of the processor of FIG. 2 in accordance with some embodiments;

FIG. 3B depicts the external memory of the processor of FIG. 2 in accordance with some embodiments;

FIG. 4A is a timing diagram depicting an exemplary transmission of beacon frames from the access point of FIG. 1 and corresponding operations of the STA of FIG. 2 for some embodiments;

FIG. 4B is a timing diagram depicting an exemplary transmission of beacon frames from the access point of FIG. 1 and corresponding operations of the STA of FIG. 2 for other embodiments;

FIG. 5 is an illustrative flow chart depicting an exemplary beacon frame processing operation in accordance with the present embodiments; and

FIG. 6 is an illustrative flow chart depicting an exemplary interrupt processing operation in accordance with the present embodiments.

Like reference numerals refer to corresponding parts throughout the drawing figures.

### DETAILED DESCRIPTION

The present embodiments are described below in the context of Wi-Fi enabled devices for simplicity only. It is to be understood that the present embodiments are equally applicable for devices using signals of other various wireless standards or protocols. As used herein, the terms WLAN and Wi-Fi can include communications governed by the IEEE 802.11 standards, Bluetooth, HiperLAN (a set of wireless standards, comparable to the IEEE 802.11 standards, used primarily in Europe), and other technologies having relatively short radio propagation range. The term “associated AP” refers to an AP of a WLAN that currently has an established communication channel or link with a STA, and the term “non-associated AP” refers to an AP of the WLAN that does not currently have an established communication channel or link with the STA.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scopes all embodiments defined by the appended claims.

FIG. 1 is a block diagram of a wireless network 100 within which the present embodiments may be implemented. The wireless network 100 is shown to include an access point (AP) 110, three wireless stations (STAs) 121-123, a server 130, and an external network 140. External network 140, which may represent any suitable network such as a local area network (LAN), a wide area network (WAN), a metro area network (MAN), and/or the Internet, is coupled to server 130 via a connection 131. Server 130, which is coupled to AP 110 via a connection 132, may facilitate the exchange of information between AP 110 and the external network 140. Connections 131 and 132 may be either wired connections or wireless connections.

AP 110 may form a basic service set (BSS) that provides STAs 121-123 with access to external network 140 via server 130. For some embodiments, AP 110 may communicate with STAs 121-123 via a suitable wireless medium according to the IEEE 802.11 family of standards (or according to other suitable wireless protocols). Although only one AP 110 is shown in FIG. 1 for simplicity, it is to be understood that wireless network 100 may include any suitable number of APs (e.g., to form an extended service set). Similarly, although only three STAs 121-123 are shown in FIG. 1 for simplicity, it is to be understood that wireless network 100 may include any suitable number of STAs.

AP 110 may be assigned a unique MAC address that is programmed therein by, for example, the manufacturer of the AP 110. Similarly, each of STAs 121-123 may be assigned a unique MAC address. Each MAC address, which may be commonly referred to as the “burned-in address,” the organizationally unique identifier (OUI), or the BSSID, in one embodiment includes six bytes of data. The first 3 bytes of the MAC address may identify which organization manufactured the device, and may be assigned to such organizations by the Institute of Electrical and Electronic Engineers (IEEE). The second 3 bytes of the MAC address, which may be referred to as the network interface controller (NIC) specific bytes, may be used to uniquely identify the individual device. In addition, AP 110 may assign each of the STAs 121-123 a unique association identifier (AID) and maintain a mapping of the AID and MAC addresses for the STAs 121-123. The AIDs assigned to the STAs 121-123 may be used to indicate which STAs have downlink data buffered in the AP 110, as described in more detail below.

The STAs 121-123 may be any suitable wireless device including, for example, a smartphone, PDA, tablet computer, laptop computer, or the like. For exemplary embodiments described herein, the STAs 121-123 may also include suitable Bluetooth modules (not shown for simplicity) to enable information exchanges using suitable Bluetooth communication protocols. For example, in one exemplary embodiment (as depicted in FIG. 1), STAs 121-123 may communicate with AP 110 using Wi-Fi signals, and STAs 121-123 may communicate with each other and/or with associated peripheral devices (e.g., headsets and speakers) using Bluetooth signals. Further, although described herein as operating in an infrastructure mode, STAs 121-123 may also operate in an ad-hoc or peer-to-peer mode.

The STAs 121-123 may operate in one of two modes according to the IEEE 802.11 standards: active mode and power save mode. While operating in the active mode, the STAs 121-123 remain in an awake state and may therefore transmit or receive data at any time. Because the STAs 121-123 constantly monitor the wireless medium in the active mode, the AP 110 may deliver data frames to STAs 121-123 without buffering. Thus, although STAs 121-123 operating in the active mode may continually transmit and receive data, power consumption may be significant.

Conversely, while operating in the power save mode, the STAs 121-123 may transition between an awake state and a sleep state. During the sleep state, the STAs 121-123 may power down various components (e.g., transceivers, processors, buses, and the like) to reduce power consumption. Because the STAs 121-123 are not able to receive (or transmit) data during the sleep state, the STAs 121-123 may periodically wake-up to listen for beacon frames and/or other information transmitted by the AP 110. The AP 110 may buffer downlink data destined for STAs 121-123 that are in the sleep state, and may include indications of the presence of buffered downlink data within the beacon frames.

In accordance with the IEEE 802.11 standards, the AP 110 may transmit beacon frames at regularly scheduled time periods to announce the existence of wireless network 100, to synchronize timer values of the STAs 121-123, and to indicate the presence of buffered downlink data in the AP 110. The number of time units between target beacon transmission times (TBTTs) is referred to as the “beacon interval,” the value of which may be included within the beacon frames.

The STAs 121-123 may determine whether the AP 110 has buffered downlink data by analyzing bitmap information in a traffic indication map (TIM) element contained in the beacon frames. The TIM element includes a partial virtual bitmap that provides a one to one mapping between bits in the bitmap and the AIDs assigned to the STAs 121-123. Thus, when the AP 110 assigns AIDs to the STAs 121-123 during an association procedure, each STA associated with the AP 110 is assigned one bit in the bitmap of the TIM. If the TIM element in a beacon frame indicates the presence of buffered downlink data for the STA, then the STA remains in the awake state until the data is delivered. Otherwise, the STA may return to the sleep state after receiving the beacon frame.

A beacon frame may indicate whether there are unicast data frames or broadcast/multicast (B/M) data frames buffered by the AP 110. Unicast frames are frames that are intended for delivery to a specific one of STAs 121-123. Multicast frames are frames that are intended for delivery to a group of the STAs 121-123. Broadcast frames are frames that are intended for delivery to all STAs 121-123 associated with the AP 110.

The AP 110 may buffer unicast frames for corresponding STAs 121-123 that are in the power save (PS) mode, and may announce the presence of these buffered unicast frames using the TIM element in a beacon frame. If a STA wakes-up from the sleep state and determines that its associated bit in the TIM element is asserted, the STA may send a PS-poll request to the AP 110. In response thereto, the AP 110 transmits the buffered unicast data to the requesting STA.

The AP 110 may buffer all incoming B/M frames if any of STAs 121-123 are in the PS mode, and may announce the presence of these buffered B/M frames using a delivery traffic indication message (DTIM) provided within selected beacon frames. After the AP 110 transmits a DTIM within a beacon frame, the AP 110 may send the buffered B/M frames to the STAs 121-123 without receiving PS poll requests from the STAs 121-123. Thus, a DTIM is a special TIM. The DTIMs are transmitted according to a DTIM period and a DTIM count value.

The DTIM count value, which is typically included within the TIM elements of the beacon frames, may indicate whether the current beacon frame includes the DTIM (e.g., rather than the ordinary TIM). More specifically, the DTIM count value indicates how many beacon frames remain to be transmitted until the next DTIM. The DTIM count value is initially set to correspond with the DTIM period, and is decremented (e.g., by 1) each time the AP 110 transmits a beacon frame. When the DTIM count value reaches zero, the AP 110 transmits the DTIM in the current beacon frame. Thus, the STAs 121-123 may determine whether the current beacon frame contains a DTIM by examining the value of the DTIM count value.

FIG. 2 shows a STA 200 that is one embodiment of one or more of STAs 121-123 of FIG. 1. STA 200 is shown to include a transceiver 210, a baseband module 220, a processor 230, a system bus 235, a memory controller 240, an external memory 250, and a memory bus 260. Transceiver 210, which is coupled to one or more antennas (ANT) and to baseband module 220, may be used to transmit signals to and receive signals from the AP 110 and/or other wireless devices (e.g., such as STAs 121-123 of FIG. 1). For some embodiments, transceiver 210 may facilitate the exchange of Wi-Fi signals, Bluetooth signals, and/or cellular signals (or signals of other suitable wireless communication protocols). For at least one embodiment, STA 200 may include multiple transceivers each dedicated to one or more corresponding wireless communication protocols (e.g., a first transceiver for communicating Wi-Fi signals, a second transceiver for communicating Bluetooth signals, a third transceiver for communicating cellular signals, and so on). For other embodiments, antenna ANT may be eliminated, and transceiver 210 may be coupled to a wired medium (e.g., twisted pair cables, coax cables, fiber optic cables, and the like).

Baseband module 220, which is coupled to transceiver 210 and to processor 230, may process signals received from transceiver 210 for delivery to processor 230, and may process signals received from processor 230 for delivery to transceiver 210. For example, for at least one embodiment, baseband module 220 may include components such as signal impairment compensation units (e.g., to compensate for I/Q mismatch). Baseband module 220 may be any suitable baseband circuit or processor, and therefore its operation is not described in detail herein.

Processor 230 is coupled to memory controller 240 via system bus 235, which may be of any suitable system bus architecture (e.g., operating according to one or more of the Advanced Microcontroller Bus Architecture (AMBA) standards, Network-on-a-Chip (NOC) protocols, and so on). Processor 230 may include any number of suitable processor cores for executing the scripts or instructions of one or more associated software programs or modules. For some embodiments, processor 230 may be a wireless connectivity processor that handles wireless communications (e.g., Wi-Fi, Bluetooth, and/or cellular signals). For at least one other embodiment, processor 230 may perform the functions of baseband module 220 (thereby eliminating the separate baseband module 220 shown in FIG. 2), and may be coupled to transceiver 210 via a suitable GPIO interface. Processor 230 also includes an internal (e.g., integrated or on-chip) memory 231 that may store frequently used instructions and data, as described in more detail below.

For some embodiments, processor 230 may be a low-power auxiliary processor residing within a mobile service modem or mobile data modem (MSM/MDM) of the STA 200, and may be configured to complement the operations of a main central processing unit (CPU) provided within the STA 200. For simplicity, the CPU and MSM/MDM are not shown in FIG. 2. For at least one embodiment, processor 230 may control the STA 200's peripherals and provide system functionality while the main CPU is deactivated, such as in “off,” “standby” or “sleep” modes. In this manner, processor 230 may perform certain tasks (e.g., transmitting and receiving data, maintaining wireless links, displaying data for a user, and so on) in a manner that reduces power consumption (e.g., compared with the STA 200's main CPU).

Memory controller 240 is coupled to processor 230 via system bus 235, and is coupled to external memory 250 via memory bus 260. Memory controller 240, which may be any suitable memory controller, controls access to external memory 250, and controls read and write operations for external memory 250.

For the exemplary embodiments described herein with respect to FIG. 2, baseband module 220, processor 230, system bus 235, and memory controller 240 are formed as integrated components within a system-on-a-chip (SoC) 215, wherein transceiver 210 and external memory 250 are external to SoC 215. For other embodiments, memory controller 240 and/or baseband module 220 may be formed as discrete components external to SoC 215. Thus, while described with respect to SoC 215 of FIG. 2, the present embodiments are applicable to any device in which a processor (e.g., processor 230) includes an on-board memory (e.g., internal memory 231) and is coupled to an off-chip memory (e.g., external memory 250).

External memory 250 is coupled to memory controller 240 via memory bus 260, which may be any suitable bus that can facilitate the transfer of data (e.g., stored data values and instructions) and control information (e.g., read and write addresses) between external memory 250 and memory controller 240. External memory 250 may be any suitable memory or storage device including, for example, DRAM, SRAM, EEPROM, EPROM, and flash memory. For at least one embodiment, external memory 250 is a double data rate (DDR) DRAM device.

As mentioned above, internal memory 231 is formed (e.g., integrated) within processor 230. Internal memory 231 may be any suitable memory or storage device including, for example, SRAM, DRAM, EEPROM, EPROM, and flash memory. For at least one embodiment, internal memory 231 is a cache-type memory device such as SRAM that is smaller and faster than external memory 250. As a result, internal memory 231 may exchange data with processor 230 at higher speeds and/or with lower latencies than external memory 250.

As shown in FIG. 2, internal memory 231 stores at least a set of first instructions I1, and external memory 250 stores at least a set of second instructions I2. Further, internal memory 231 and/or external memory 250 may store status and state information reflecting a current operating state of processor 230, as well as other information such as system data, application data, data structures, and/or application context data. Although internal memory 231 and external memory 250 may be of any suitable sizes, for at least some embodiments, external memory 250 is at least an order of magnitude larger than internal memory 231.

The first instructions I1, which for some embodiments may be a relatively small subset of the second instructions I2 stored in the external memory 250, are to perform one or more selected low-power operations for STA 200 when executed by processor 230. For one example, the selected low-power operations may relate to Wi-Fi operations and include (1) waking up to listen for beacon frames and (2) determining whether an associated AP (e.g., AP 110 of FIG. 1) has queued downlink data for the STA 200. For another example, the selected low-power operations may relate to Bluetooth operations and include performing Bluetooth low power page scan operations. For some embodiments, the first instructions I1 may include firmware and/or other boot-up information for processor 230.

The second instructions I2, which are stored in external memory 250, may include the operating system (OS) for processor 230, application software modules, and other programs or software modules for performing functions related to the operation of STA 200. The second instructions I2 may also perform one or more of the operations performed by execution of the first instructions I1 stored in the internal memory 231.

Performing selected operations by executing the first instructions I1 stored in internal memory 231 without accessing the external memory 250 may provide power savings and increase performance for a variety of reasons. For example, because internal memory 231 is faster than external memory 250, processor 230 may access data stored in internal memory 231 much faster than data stored in the external memory 250. Further, when executing the first instructions I1 stored in the internal memory 231, the processor 230 may not need to access the external memory 250, thereby allowing memory controller 240 and/or system bus 235 to remain in a disabled or a partially disabled state. In addition, by not accessing external memory 250, processor 230 may avoid latencies associated with external memory 250 and/or may avoid access/contention issues associated with the system bus 235. For situations in which the system bus 235 remains operational, the number of transactions and/or the clock speed of system bus 235 may be reduced when processor 230 is not accessing external memory 250. Moreover, the first instructions I1 may include a wake-up routine or boot-up instructions to wake-up the processor 230 and/or to put the processor 230 to sleep without accessing external memory 250, thereby increasing the speed with which the STA 200 may enter and exit the sleep state (e.g., as compared to the wake-up and sleep timeline associated with executing corresponding routines stored in the external memory 250).

Processor 230 may switch between executing the first instructions I1 stored in internal memory 231 and executing the second instructions I2 stored in external memory 250 by exchanging (e.g., communicating) operating state information between internal memory 231 and external memory 250. The operating state information may include, for example, program counter (PC) values, data structure information, buffer addresses, an indication that data is stored in a buffer, pending interrupts (INTs), timer values, and so on. In this manner, processor 230 may perform one or more selected low-power operations by executing the first instructions I1 stored in internal memory 231. If more complex operations are subsequently requested or desired, then processor 230 may jump (e.g., transition) to executing the second instructions I2 stored in external memory 250.

Transitions between executing the first instructions I1 stored in internal memory 231 and executing the second instructions I2 stored in external memory 250 (and back again) may be triggered or initiated in any suitable manner. For one embodiment, execution of the first instructions I1 may result in determining that more complex operations are to be performed (e.g., operations that cannot be performed by the first instructions I1), in which case execution of the first instructions I1 may cause processor 230 to jump to a program, routine, or sub-routine associated with the second instructions I2 stored in external memory 250. Similarly, execution of the second instructions I2 may result in determining that only less complex operations (e.g., the aforementioned selected low-power operations) are to be performed, in which case execution of the second instructions I2 may cause processor 230 to jump to a program, routine, or sub-routine associated with the first instructions I1 stored in internal memory 231.

For another embodiment, a monitoring of upcoming or scheduled interrupts (INTs) may be used to determine whether to transition between execution of the first instructions I1 stored in internal memory 231 and execution of the second instructions I2 stored in external memory 250. For example, if the next INT is associated with waking up from the sleep state to listen for beacon frames, then processor 230 may wake-up and listen for beacon frames using the first instructions without accessing the external memory 250. Conversely, if the next INT is associated with transmitting data or some other “complex” operation (defined herein as an operation that the first instructions I1 stored in the internal memory 231 are not configured to perform), then processor 230 may schedule the next wake-up operation to be performed by executing the second instructions I2 stored in the external memory 250.

FIG. 3A shows a memory 300 that is one embodiment of internal memory 231 of FIG. 2. Memory 300 may include or be associated with a non-transitory computer-readable medium (e.g., one or more nonvolatile memory elements, such as EPROM, EEPROM, Flash memory, a hard drive, and so on) that can store at least the following example software modules:
a power save software module 302 to selectively enter and/or exit the sleep state (e.g., as described for operations 502, 503, and/or 508 of FIG. 5);
a low power software module 304 to perform one or more selected low power operations such as listening for beacon frames to determine whether the beacon frames indicate a presence of downlink data buffered in an associated access point (e.g., as described for operations 504, 505, and/or 506 of FIG. 5) and/or to perform Bluetooth low power page scan operations;
a jump software module 306 to selectively transition from execution of the first instructions I1 stored in internal memory 231 to execution of the second instructions I2 stored in external memory 250 (e.g., as described for operation 510 of FIG. 5); and
a management software module 308 to manage one or more functions and/or to support one or more tasks of processor 230 when awake (e.g., to manage timer interrupts).
   Each software module includes instructions that, when executed by processor 230, can cause the STA 200 to perform the corresponding functions. Thus, the non-transitory computer-readable medium of memory 300 can include the first instructions I1 for performing all or a portion of the operations of method 500 of FIG. 5.

FIG. 3B shows a memory 350 that is one embodiment of external memory 250 of FIG. 2. Memory 350 may include or be associated with a non-transitory computer-readable medium (e.g., one or more nonvolatile memory elements, such as EPROM, EEPROM, Flash memory, a hard drive, and so on) that can store at least the following example software modules:
a power save software module 352 to selectively enter and/or exit the sleep state (e.g., as described for operations 518 and 522 of FIG. 5);
WLAN/BT processing software module 354 to facilitate the exchanges of Wi-Fi and Bluetooth signals with other devices;
a jump software module 356 to selectively transition from execution of the second instructions I2 stored in external memory 250 to execution of the first instructions I1 stored in internal memory 231 (e.g., as described for operations 516 and 520 of FIG. 5); and
a boot-up software module 358 to boot-up processor 230 (e.g., from a sleep state, idle state, or power-saving state and as described for operation 524 of FIG. 5).
   Each software module includes instructions that, when executed by processor 230, can cause the STA 200 to perform the corresponding functions. Thus, the non-transitory computer-readable medium of memory 350 can include the second instructions I2 for performing all or a portion of the operations of method 500 of FIG. 5.

An exemplary operation of listening for and processing beacon frames transmitted from the AP 110 of FIG. 1 is described below with respect to the illustrative timing diagram 400 of FIG. 4A and the method 500 represented by the exemplary flow chart of FIG. 5. Initially, prior to time t₀, the STA 200 is in the sleep state. Just before time t₀, which corresponds to the first TBTT of AP 110, the STA 200 wakes up from the sleep state to listen for a beacon frame transmitted from the AP 110 (502). More specifically, processor 230 of STA 200 may access the first instructions I1 stored in internal memory 231 and execute a suitable wake-up routine therein to boot-up the processor 230 (503). In this manner, processor 230 may quickly wake up without having to contend for access to system bus 235, without having to power-up memory controller 240, and without having to access or retrieve information from external memory 250. As a result, traffic on system bus 235 may be reduced and/or system bus 235 may operate at lower speeds, and processor 230 may not request the system bus 235's clock (not shown for simplicity).

For at least some embodiments, processor 230 may wake-up in response to a program interrupt (INT) contained within the first instructions I1 and corresponding to the scheduled transmission of the first beacon frame B1.

At time t₀, the AP 110 transmits the first beacon frame B1, which contains a DTIM indicating that the AP 110 does not have any B/M frames buffered for STA 200. The STA 200 receives the beacon frame B1 (504), and determines whether the DTIM bit is asserted to indicate the presence of buffered downlink data (505). More specifically, the processor 230 may receive the beacon frame and determine whether the DTIM bit is asserted by executing the first instructions I1 residing in the processor's internal memory 231 without executing the second instructions I2 stored in external memory 250. As a result, processor 230 does not need to access system bus 235, does not need to enable memory controller 240, and does not need to access or retrieve information from external memory 250.

Because the DTIM bit is not asserted, as tested at 506, the STA 200 may return to the sleep state, and the processor 230 may enter a sleep or idle state (508). In this manner, the STA 200 may wake-up from the sleep state, receive the first beacon frame B1, determine whether the first beacon frame B1 includes an asserted DTIM bit, and then return to the sleep state without executing the second instructions I2 stored in external memory 250 (e.g., and therefore without accessing system bus 235, without enabling memory controller 240, and without access external memory 250). Thus, by entering and existing the sleep state by executing only the first instructions I1 stored in the internal memory 231 (which has faster access times than external memory 250), the timeline and power consumption associated with entering and exiting the sleep state may be reduced (as compared to wireless devices that execute instructions stored in an external memory such as external memory 250 to enter and exit the sleep state). Thereafter, processing may continue at 502 to listen for subsequent beacon frames.

Next, at time t₁, which corresponds to the second TBTT of AP 110, the AP 110 transmits the second beacon frame B2, which contains a TIM. Because the second beacon frame B2 does not include a DTIM, the STA 200 may not wake-up from the sleep state, but rather may remain in the sleep state until the next DTIM is transmitted from the AP 110 in the fourth beacon frame B4, at time t₃. The STA 200 may use the DTIM count value provided in the first beacon frame B1 to determine that the next two beacon frames B2-B3 do not contain DTIMs. Note that the DTIM period depicted in FIG. 4A is exemplary, and thus may have other suitable values.

For other embodiments, the processor 230 may (e.g., in response to program INTs contained within the first instructions I1) cause the STA 200 to wake-up for every beacon frame (or every Nth beacon frame), for example, as depicted by the illustrative timing diagram 401 of FIG. 4B. The program INTs may cause the STA 200 to wake up for selected beacon intervals by adjusting the STA 200's listen interval (e.g., in accordance with the IEEE 802.11 standards). Waking up more frequently to listen for beacon frames consumes more power, but may ensure that buffered unicast frames are delivered more frequently from the AP 110 to the STA 200. For such embodiments, the processor 230 may process the TIM bits contained in the beacon frames in a manner similar to that as described herein for the DTIM bits. That is, if the TIM bit indicates that the AP 110 does not have buffered (unicast) data for the STA 200, then the STA 200 may return to the sleep state. Otherwise, the processor 230 may jump from execution of the first instructions stored in the internal memory 231 to the second instructions I2 stored in the external memory 250 to process the received data.

Just before time t₃, which corresponds to the fourth TBTT of AP 110, the STA 200 wakes up from the sleep state to listen for a beacon frame transmitted from the AP 110 (502). As described above, processor 230 of STA 200 may access first instructions I1 stored in internal memory 231 and execute a suitable wake-up routine therein to boot-up the processor 230 (503).

At time t₃, the AP 110 transmits the fourth beacon frame B4, which contains a DTIM indicating that the AP 110 has at least one B/M frame buffered for STA 200. The STA 200 receives the beacon frame B4 (504), and determines whether the DTIM bit is asserted to indicate the presence of buffered downlink data (505). As described above, the processor 230 may receive the beacon frame and determine whether the DTIM bit is asserted by executing the first instructions I1 residing in the processor's internal memory 231 (e.g., without executing the second instructions I2 stored in external memory 250).

Because the DTIM bit in the fourth beacon frame B4 is asserted (to indicate that the AP 110 has queued downlink data for the STA 200), as tested at 506, subsequent execution of the first instructions I1 may request access to system bus 235, may activate memory controller 240, may communicate operating state information to external memory 250, and may then jump program execution from the first instructions I1 to the second instructions I2 residing within the external memory 250 (510). For some embodiments, information corresponding to a next INT associated with processing the downlink data to be received from the AP 110 may be provided to the external memory 250 as part of the operating state information. The operating state information may also include system data, application data, application context data, and/or data structures.

Thereafter, the processor 230 may process downlink data received from the AP 110 by executing the second instructions I2 residing in the external memory 250 (512). For some embodiments, processor 230 may receive the downlink data transmitted from the AP 110 and store the downlink data in a suitable buffer while (or until) program execution transitions from the first instructions I1 stored in the internal memory 231 to the second instructions I2 stored in the external memory 250. For such embodiments, the operating state information provided to the external memory 250 by processor 230 may include one or more pointer values indicating where the downlink data is stored in the buffer. As mentioned above, the processor 230 may jump program execution from the first instructions I1 to the second instructions I2 (e.g., in response to an asserted DTIM bit) because the first instructions I1 are not to perform more “complex” operations such as processing downlink data received from the AP 110. In this manner, the first instructions I1 may be relatively compact (as compared to the second instructions I2), which in turn allows the internal memory 231 provided within the processor 230 to be relatively small (as compared to the external memory 250).

As mentioned above, for embodiments in which the STA 200 wakes up to listen for beacon frames having TIM elements (as opposed to DTIM bits), the processor 230 may initially wake up to listen for such beacon frames by executing the first instructions I1, and may then jump to execution of the second instructions I2 stored in external memory 250 if the associated TIM indicates that the AP 110 has buffered unicast frames for the STA 200. Thereafter, the processor 230 may transmit a PS-poll request and subsequently process the received unicast data by executing the second instructions I2 stored in external memory 250.

Next, the processor 230 executes the second instructions I2 stored in the external memory 250 to determine whether the next INT is related to beacon frame listening operations (514). If so, then execution of the second instructions I2 may communicate operating state information to the processor 230's internal memory 231 (516), thereby allowing the first instructions I1 stored in the internal memory 231 to subsequently wake-up the STA 200 from the sleep state. After communicating the operating state information to the internal memory 231, processor 230 returns the STA 200 to the sleep state (e.g., by executing the second instructions I2) (518), and processing continue at 502.

Conversely, if the next INT indicates an operation other than listening for a beacon frame (or other selected low power operations to be performed by executing the first instructions I1), as tested at 514, then processor 230 may select the second instructions I2 stored in external memory 250 to perform the next wake-up operation (520). Then, processor 230 returns the STA 200 to the sleep state (e.g., by executing the second instructions I2) (522).

Thereafter, processor 230 may wake-up the STA 200 from the sleep state by executing the second instructions I2 stored in external memory 250 to handle the next operation (e.g., as indicated by the next program INT) (524).

As mentioned above, the present embodiments may also be used to perform Bluetooth low power page scan (LPPS) operations and/or other selected operations for which corresponding instructions may be stored entirely within the internal memory 231 of processor 230. An exemplary operation for performing such operations is described below with respect to the method 600 represented by the exemplary flow chart of FIG. 6. First, the STA 200 wakes up from the sleep state to process an INT (602). More specifically, processor 230 of STA 200 may access the first instructions I1 stored in internal memory 231 and execute a suitable wake-up routine therein to boot-up the processor 230 (603). In this manner, processor 230 may quickly wake up without having to contend for access to system bus 235, without having to power-up memory controller 240, and without having to access or retrieve information from external memory 250. As a result, traffic on system bus 235 may be reduced and/or system bus 235 may operate at lower speeds, and processor 230 may not request the system bus 235's clock (not shown for simplicity).

If the INT is associated with listening for a WLAN beacon frame or for performing a Bluetooth (BT) LPPS operation, as tested at 604, then the processor 230 may process the INT by executing the first instructions I1 residing in the processor's internal memory 231 (606). Thereafter, the STA 200 may return to the sleep state, and the processor 230 may enter a sleep or idle state (608). In this manner, the STA 200 may wake-up from the sleep state, process the INT, and then return to the sleep state without executing the second instructions I2 stored in external memory 250 (e.g., and therefore without accessing system bus 235, without enabling memory controller 240, and without access external memory 250). Thus, by entering and existing the sleep state by executing only the first instructions I1 stored in the internal memory 231, the timeline and power consumption associated with entering and exiting the sleep state may be reduced. Thereafter, processing may continue at 602 to process a next INT.

Conversely, if the INT is not associated with listening for a WLAN beacon frame or for performing a Bluetooth LPPS operation (e.g., but rather is associated with a more complex operation), as tested at 604, then the processor 230 may request access to system bus 235, may activate memory controller 240, may communicate operating state information to external memory 250, and may then jump program execution from the first instructions I1 to the second instructions I2 residing within the external memory 250 (610). For some embodiments, a PC value corresponding to the INT may be provided to the external memory 250 as part of the operating state information. The operating state information may also include system data, application data, application context data, and/or data structures. Thereafter, the processor 230 may process the INT by executing the second instructions I2 residing in the external memory 250 (612).

Next, the processor 230 executes the second instructions I2 stored in the external memory 250 to determine whether a next INT is related to beacon frame listening operations or for Bluetooth LPPS operations (614). If so, then execution of the second instructions I2 may communicate operating state information to the processor 230's internal memory 231 (616), thereby allowing the first instructions I1 stored in the internal memory 231 to subsequently wake-up the STA 200 from the sleep state. After communicating the operating state information to the internal memory 231, processor 230 returns the STA 200 to the sleep state (e.g., by executing the second instructions I2) (618), and processing continue at 602.

Conversely, if the next INT indicates an operation other than listening for a beacon frame or performing Bluetooth LPPS operations, as tested at 614, then processor 230 may select the second instructions I2 stored in external memory 250 to perform the next wake-up operation (620). Then, processor 230 returns the STA 200 to the sleep state (e.g., by executing the second instructions I2) (622). Thereafter, processor 230 may wake-up the STA 200 from the sleep state by executing the second instructions I2 stored in external memory 250 to handle the next operation (e.g., as indicated by the next INT) (624). In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense. For example, method steps depicted in the flow charts of FIGS. 5 and 6 may be performed in other suitable orders and/or one or more methods steps may be omitted. Further, although described herein with respect to waking up to listen for beacon frames without accessing external memory 250 or executing the second instructions I2 stored therein, wireless devices in accordance with the present embodiments are equally applicable for performing other selected operations.

What is claimed is:

1. In a wireless station comprising a processor that includes an internal memory and that is coupled to an external memory via a bus, a method comprising:
waking up the processor from a sleep state to receive a beacon frame from an access point, wherein the beacon frame includes a traffic indication bit indicating whether the access point has downlink data for the station;
determining whether the traffic indication bit is asserted by executing a set of first instructions residing in the internal memory;
placing the processor into the sleep state by executing the first instructions if the traffic indication bit is not asserted; and
processing the downlink data received from the access point by executing a set of second instructions residing in the external memory if the traffic indication bit is asserted.

2. The method of claim 1, wherein the traffic indication bit comprises a delivery traffic indication message (DTIM) bit or a traffic indication map (TIM) bit.

3. The method of claim 1, wherein the waking up is performed by executing the first instructions without executing the second instructions.

4. The method of claim 1, wherein the second instructions are not executed during the determining.

5. The method of claim 1, wherein the bus and the external memory remain inactive during the determining.

6. The method of claim 1, wherein the first instructions are a subset of the second instructions.

7. The method of claim 1, wherein the processing comprises:
communicating operating state information from the internal memory to the external memory;
requesting access to the bus; and
jumping from an execution of the first instructions residing in the internal memory to an execution of the second instructions residing in the external memory using the operating state information.

8. The method of claim 7, wherein the operating state information comprises at least one of a program counter value, a data structure format, and a pending program interrupt (INT) indication.

9. The method of claim 1, further comprising:
determining whether a next interrupt is associated with listening for a subsequent beacon frame by executing the second instructions; and
selectively communicating operating state information from the external memory to the internal memory in response to the next interrupt.

10. The method of claim 9, wherein the selectively communicating comprises:
providing a program counter value from the external memory to the internal memory; and
processing the next interrupt by executing the first instructions residing in the internal memory without executing the second instructions residing in the external memory.

11. A wireless station comprising:
a transceiver to exchange data with a wireless device;
a processor including an internal memory to store a set of first instructions;
an external memory, coupled to the processor by a bus, to store a set of second instructions, wherein the first instructions are a subset of the second instructions, wherein the processor is to:
wake up from a sleep state to receive a beacon frame from an access point, wherein the beacon frame includes a traffic indication bit indicating whether the access point has downlink data for the station;
determine whether the traffic indication bit is asserted by executing the first instructions residing in the internal memory without executing the second instructions residing in the external memory;
return to the sleep state by executing the first instructions if the traffic indication bit is not asserted; and
process the downlink data received from the access point by executing the second instructions if the traffic indication bit is asserted.

12. The wireless station of claim 11, wherein the processor is to wake up by executing the first instructions without executing the second instructions.

13. The wireless station of claim 11, wherein the bus and the external memory remain inactive when the processor is to determine whether the traffic indication bit is asserted.

14. The wireless station of claim 11, wherein the processor and the bus comprise a system-on-a-chip (SoC), and the external memory is coupled to the SoC by another bus.

15. The wireless station of claim 11, wherein the processor is to process the downlink data by:
communicating operating state information from the internal memory to the external memory;
requesting access to the bus; and
jumping from an execution of the first instructions residing in the internal memory to an execution of the second instructions residing in the external memory using the operating state information.

16. The wireless station of claim 11, wherein the processor is to further:
determine whether a next interrupt is associated with listening for a subsequent beacon frame by executing the second instructions; and
selectively communicate operating state information from the external memory to the internal memory in response to the next interrupt.

17. The wireless station of claim 16, wherein the processor is to selectively communicate the operating state information by:
providing a program counter value from the external memory to the internal memory; and
processing the next interrupt by executing the first instructions residing within the internal memory without executing the second instructions residing in the external memory.

18. A wireless station comprising a processor that includes an internal memory and that is coupled to an external memory via a bus, the wireless station comprising:
means for waking up the processor from a sleep state to receive a beacon frame from an access point without accessing the external memory, wherein the beacon frame includes a traffic indication bit indicating whether the access point has downlink data for the station;
means for determining whether the traffic indication bit is asserted without accessing the external memory;
means for placing the processor into the sleep state without accessing the external memory if the traffic indication bit is not asserted; and
means for processing the downlink data received from the access point using instructions stored in the external memory if the traffic indication bit is asserted.

19. The wireless station of claim 18, wherein the processor and the bus comprise a system-on-a-chip (SoC), and the external memory is coupled to the SoC by another bus.

20. The wireless station of claim 18, wherein the means for processing comprises:
means for communicating operating state information from the internal memory to the external memory;
means for requesting access to the bus; and
means for jumping from an execution of instructions residing in the internal memory to an execution of instructions residing in the external memory in response to the operating state information.

21. The wireless station of claim 20, wherein the operating state information comprises at least one of a program counter value, a data structure format, and a pending program interrupt (INT) indication.

22. The wireless station of claim 18, further comprising:
means for determining whether a next interrupt is associated with listening for a subsequent beacon frame by executing the instructions residing within the external memory; and
means for selectively communicating operating state information from the external memory to the internal memory in response to the next interrupt.

23. The wireless station of claim 22, wherein the selectively communicating comprises:
providing a program counter value from the external memory to the internal memory; and
processing the next interrupt by executing instructions residing within the internal memory without executing the instructions residing in the external memory.

24. A computer-readable storage medium containing program instructions that, when executed by a processor of a wireless station associated with an access point in a wireless network, causes the wireless station to:
wake up the processor from a sleep state to receive a beacon frame from the access point, wherein the beacon frame includes a traffic indication bit indicating whether the access point has downlink data for the station;
determine whether the traffic indication bit is asserted by executing a set of first instructions residing in an internal memory of the processor without executing a set of second instructions residing in an external memory coupled to the processor;
return the processor to the sleep state by executing the first instructions if the traffic indication bit is not asserted; and
process the downlink data received from the access point by executing the second instructions if the traffic indication bit is asserted.

25. The computer-readable storage medium of claim 24, wherein the processor is to wake up by executing the first instructions without executing the second instructions.

26. The computer-readable storage medium of claim 24, wherein the external memory and a bus coupled to the processor remain inactive when the processor is to determine whether the traffic indication bit is asserted.

27. The computer-readable storage medium of claim 24, wherein the processor and a memory controller associated with the external memory comprise a system-on-a-chip (SoC), and the external memory is coupled to the SoC by a bus.

28. The computer-readable storage medium of claim 24, wherein execution of the program instructions when processing the downlink data further cause the station to:
communicate operating state information from the internal memory to the external memory;
request access to the bus; and
jump from an execution of the first instructions residing in the internal memory to an execution of the second instructions residing in the external memory using the operating state information.

29. The computer-readable storage medium of claim 24, wherein execution of the program instructions further cause the station to:
determine whether a next interrupt is associated with listening for a subsequent beacon frame by executing the second instructions; and
selectively communicate operating state information from the external memory to the internal memory in response to the next interrupt.

30. The computer-readable storage medium of claim 24, wherein execution of the program instructions to selectively communicate the operating state information further cause the station to:
provide a program counter value from the external memory to the internal memory; and
process the next interrupt by executing the first instructions residing within the internal memory without executing the second instructions residing in the external memory.
